(19) United States
(12) Patent Application Publication
(10) Pub. No.: US 2005/0020162 A1
(43) Pub. Date: Jan. 27, 2005

(54) Sortable adhesive coated paper articles

(76) Inventors: Steven J. Severtson, Shoreview, MN (US); Xinping Wang, Zhejiang (CN); Michael J. Nowak, Naperville, IL (US)

Correspondence Address: Dorothy P Whelan;Fish & Richardson, Suite 3300, 60 South Sixth Street, Minneapolis, MN, 55402, US

(21) Appl. No.: 10/204,030

(22) PCT Filed: Jul. 17, 2002
(86) PCT No.: PCT/US02/22684

Related U.S. Application Data
(60) Provisional application No. 60/306,069, filed on Jul. 17, 2001.
(60) Provisional application No. 60/373,004, filed on Apr. 15, 2002.
(60) Provisional application No. 60/383,767, filed on May 28, 2002.

(51) Int. Cl. D06N 7/04; B32B 9/00; B32B 33/00; B32B 5/00; B32B 7/00; B32B 7/12; B32B 27/04; B32B 27/12

(52) U.S. Cl. 442/149; 442/150; 442/151; 442/59; 428/42.3; 428/98; 428/153; 428/195.1; 428/211.1; 428/221; 428/317.1

(57) ABSTRACT

An article that includes a paper substrate and an adhesive provided on the substrate. The paper substrate has a surface energy no greater than about 55 mJ/m² and a wet strength that is maintained at a sufficiently high level when the article is subjected to repulping such that the substrate remains substantially intact at the conclusion of repulping.

### RELATED CASES

This application claims priority to PCT Application Serial No. PCT/US02/22684 filed Jul. 17, 2002, which also claims priority to Provisional Application No. 60/306,069 filed Jul. 17, 2001; Provisional Application No. 60/373,004 filed Apr. 15, 2002 and Provisional Application No. 60/383,767 filed May 28, 2002, each of which is hereby incorporated in its entirety.

### STATEMENT REGARDING FEDERALLY SPONSORED RESEARCH

This invention was made with government support under DE-FC07-00ID13881 awarded by the U.S. Department of Energy. The government has certain rights in the invention.

### TECHNICAL FIELD

This invention relates generally to preparing sortable adhesive-coated paper articles.

### BACKGROUND

Many of the pressure sensitive adhesives (PSAs) produced each year are used for labels, stamps, envelopes, and other paper products that tend to become incorporated into secondary wood-fiber sources. During the repulping of wastepaper, PSAs are broken down along with recovered paper products to form particles that are suspended in aqueous process slurries. A portion of these adhesive contaminants is removed with standard mill separation techniques such as pressure screens and centrifugal cleaners. However, it currently is not possible to remove all of the adhesive contaminant using these separation techniques. The material that remains is introduced into papermaking processes, where it interferes with operations and is often retained in the final product, thereby diminishing its quality. The problems created by the presence of residual PSAs are extremely costly to the industry and are considered severe enough as to prevent the recycling of many potential sources of currently landfilled secondary fiber.

Research on methods for controlling these contaminants has been extensive over the past decade. Approaches have included avoidance methods involving the monitoring and cleaning of recycled paper sources, new equipment to aid in contaminant removal, additives for protecting key process sites, and operations and techniques for making contaminants caught in the process more benign. Although many of these approaches are successful at reducing the severity of the problem, none offers sufficient control over the contamination.

### SUMMARY

In general, the invention features an article that includes a paper substrate and an adhesive provided on the paper substrate. The paper substrate has a surface energy of no greater than about 55 mJ/m² and a wet strength that is maintained at a sufficiently high level when the article is subjected to repulping such that the substrate remains substantially intact (i.e., does not break down into individual fibers) at the conclusion of repulping.

The surface energy of the paper substrate is measured according to the protocol described in the Examples, below. By maintaining the surface energy of the paper substrate at or below about 55 mJ/m², and at the same time maintaining the wet strength of the paper sufficiently high such that it resists breaking down during repulping, the substrate may be combined with a variety of adhesives, including hot melt and water-based adhesives, and will substantially retain the adhesive during repulping of wastepaper, thereby enhancing the ability to separate adhesive contaminants during repulping using conventional systems. Adhesive removal efficiencies of least 85%, preferably at least 95%, and more preferably at least 99% can be achieved using these paper substrates.

By engineering the properties of the paper substrate, articles that essentially “self-sort” during the repulping process may be obtained. Moreover, this result may be obtained using commonly available adhesives, rather than requiring the use of specially designed adhesives.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a plot of surface energy of sized, wet strength-treated substrates and removal efficiencies as a function of size concentration for three hot melt PSA-coated substrates.

### DETAILED DESCRIPTION

The removal of a PSA from a paper substrate in an aqueous environment is controlled, in general, by the mechanical properties of the substrate (specifically, the wet strength of the paper) and the adhesion of the PSA to the substrate. The relative surface energies of the PSA and the substrate affect the adhesion of the PSA to the substrate. Designing the wet strength of the paper such that it is retained at a relatively high level during repulping, and at the same engineering the surface energy of the paper such that it is no greater than about 55 mJ/m² facilitates adhesive removal. Preferably, the surface energy of the substrate is about 25-50 mJ/m², and more preferably about 30-40 mJ/m². Such substrates can be used successfully with commonly available adhesives, including hot melt and water-based (i.e., latex) pressure sensitive adhesives.

One useful way of achieving paper substrates with the requisite wet strength and surface energy values is to treat the substrate with a combination of a wet strength resin and a sizing agent. Useful wet strength agents for treating the paper include both permanent and temporary agents, with permanent agents being preferred. There are a number of commercially available wet-strength agents that may be used. Under acid conditions, urea-formaldehyde and melamine formaldehyde resins are preferred, while under neutral alkaline conditions, resins based on polyamide epichlorohydrin chemistries are preferred. Specific examples of suitable commercially available wet strength agents include Kymene 557H, Kymene 450, Kymene 109LX, and Kymene 557LX (Hercules, Incorporated, Wilmington, Del.), Ameres 8855 and Ameres 2747 (Georgia-Pacific Resins, Inc., Decatur, Ga.), and Paramel 200 and Paramel HE-1 (Cytec Industries Inc., West Paterson, N.J.). Kymene 557H is particularly useful. It is described by Hercules as a 12.5% solids, polyamide-epichlorohydrin (PAE) type for wet strength in paper. The particular amount of wet strength agent is not critical.

Useful sizing agents for treating the paper include alkyl ketene dimers (AKD's) and the alkenyl succinic anhydrides (ASA's), in the case of alkaline papermaking, and rosin in the case of acid papermaking. All of these chemistries possess amphiphilic structures with large aliphatic components and hydrophilic, typically cellulose-reactive, functional groups. Sizing agents are introduced into the papermaking process as a colloid or react to form a colloid, which heterocoagulates with fiber used to produce paper. Other examples of suitable sizing agents include wax, sodium stearate, and fluorine-containing compounds. An example of a useful commercially available sizing agent is an alkyl ketene dimer available from Hercules Corporation (Wilmington, Del.) under the designation Hercon 70.

The adhesive may be in the form of a continuous or discontinuous coating, and may cover all or a portion of the paper surface. A variety of adhesives may be used, with pressure sensitive adhesives being preferred. Examples of useful pressure sensitive adhesives include hot melt adhesives, emulsion-based (i.e. latex-based) adhesives, and radiation-cured adhesives. Such adhesives are well-known and commercially available from suppliers such as H.B. Fuller Co. (St. Paul, Minn.) and Avery Dennison Co. (Pasadena, Calif.).

### EXAMPLES

Copper(II)-ethylenediamine complex (1 M solution in water) was purchased from Acros Organics (Pittsburgh, Pa.). All paper substrates were produced from a 50:50 w/w blend of hardwood and softwood bleached kraft fiber refined to levels similar to those used by the mill to produce paper.

Paper substrates were prepared in the form of standard 200 cm² round (diameter ≈15.96 cm) handsheets produced using TAPPI Method T-205 om-88. When sizing and wet strength agents were incorporated into the paper, the chemicals were added from 1% (w/w) aqueous solutions to a highly sheared 0.3% (w/w) aqueous slurry of fiber. Handsheet curing was carried out as needed following conventional procedures described by suppliers. When a sizing agent was applied, but a wet-strength resin was not, a coagulant was used to enhance the retention. All the handsheets were conditioned at 23° C. and 50% RH for at least 24 hours prior to testing.

The sizing agent used in each example was Hercon 70, an alkenyl ketene dimer (AKD) available from Hercules Corporation (Wilmington, Del.). Nominal AKD dosages ranged up to 0.15% of active chemical (applied) based on the oven-dried mass of fiber. The wet strength agents used in the examples were supplied by Hercules (Kymene 557H).

PSA-coated substrates prepared in the form of labels containing a known amount of PSA (≈4.5 g) were attached to various sheets of a preweighed stack of copying grade paper (886.5 g) with a heavy roller, and the entire sample was cut into 0.25″ wide strips using a commercial shredder. Tap water (8.1 L) that had been heated to 46° C. with an immersion heater was combined with the shredded sample in an Adirondack 1800H Laboratory Pulper (Adirondack, N.Y.) and mixed at 60 HZ for 20 minutes. The resulting fiber slurry was flushed into a 5-gallon container using 9 L of filtered tap water and passed through a Valley Vibrating Flat Screen equipped with a 6-cut slotted screen (i.e., slotted openings of 0.15 mm). Screening rejects containing adhesive particles and fiber were collected from the screen plate. Accepts were dewatered in a 200-mesh screen box and placed in plastic bags for further analysis. Rejected PSA particles were isolated from fibrous material for analysis by using solvent to dissolve cellulose fiber. The weighed screening rejects were combined with an equal volume of water and copper (II)-ethylenediamine (CED) solution in an Erlenmeyer flask and mixed with a magnetic stir rod for approximately 8 hours. Adhesive particles were isolated using vacuum filtration, and dried at 105° C. to a constant weight.

Rejected PSA mass is reported as a “Removal Efficiency,” which is the percentage of PSA added to the repulper sample that is rejected at the screen. Measured removal efficiencies were qualitatively checked by visually inspecting paper handsheets made from the screening accepts.

Dry and wet tensile strengths of handsheets were measured with an Instron (Canton, Mass.) Model 5542 Tensile Tester using TAPPI Methods T220 om-88 and T494 om-88, respectively. Wet and dry tensile strength (N/m), wet and dry tensile index (Nm/g), which is simply the tensile strength divided by the dry basis weight of the test sample, and tensile loss after wetting (fractional loss of tensile strength after wetting) were used to characterize the influence of resins.

Solid surface energies were determined from contact angles of selected liquids on paper substrates using a technique described by Fowkes et al., Ind. Engr. Chem. 1964, 56:40. Contact angle measurements were performed by depositing sessile drops (20 μl) of selected liquids on the paper substrate and monitoring the drop shape as a function of time using a Krüss (Hamburg, Germany) DSA 10 goniometer equipped with a Sony XC-77CE video camera. The DSA software was programmed in movie mode option and set up to ensure that the recording of contact angle measurements was triggered by the initial drop placement. The video images were captured at a rate of 25 frames per second, and the corresponding contact angle calculations were performed using the supplied software. Contact angle values were extracted subsequent to liquid spreading and prior to the onset of absorption and evaporation, as described in Modaressi, H. and Gamier, G., Langmuir 2002, 18:642.

### Example 1

Twelve hot melt PSA formulations were used to prepare samples. The results are reported in Table 1 as a removal efficiency, which is the percentage of PSA added to the sample that is isolated by the technique described above. In each case, the untreated paper substrate had a surface energy of 70 mJ/m² and a tensile loss of 0.96; the paper treated only with a wet strength resin had a surface energy of 54 mJ/m² and a tensile loss of 0.80; and the paper treated with both a wet strength resin and a sizing agent had a surface energy of 34 mJ/m² and a tensile loss of 0.78. As shown in Table 1, raising the wet strength using wet strength resin can increase removal efficiencies. Moreover, as shown in Table 1, the best removal efficiencies are obtained when both the wet strength is raised and the surface energy of the paper substrate is lowered by means of a sizing agent.

TABLE 1

| | Untreated | Wet-Strength | Sized Wet- |
|---|---|---|---|
| Hot Melt PSA | Paper | Paper | Strength Paper |
| 1 | 95.8 | 96.1 | 99.7 |
| 2 | 88.0 | 88.0 | 99.4 |
| 3 | 98.8 | 98.8 | 100 |
| 4 | 97.5 | 97.9 | 99.5 |
| 5 | 3.30 | 71.3 | 89.3 |
| 6 | 2.00 | 62.9 | 88.6 |
| 7 | 77.8 | 76.4 | 92.5 |
| 8 | 95.6 | 94.1 | 96.1 |
| 9 | 21.4 | 50.0 | 92.7 |
| 10 | 89.1 | 90.4 | 96.5 |
| 11 | 88.1 | 90.7 | 95.4 |
| 12 | 42.0 | 76.0 | 93.5 |

### Example 2

Eight water-based PSA formulations were used to prepare samples. The results are reported in Table 2 as a removal efficiency, which is the percentage of PSA added to the sample that is isolated by the technique described above. In each case, the untreated paper substrate had a surface energy of 70 mJ/m² and a tensile loss of 0.96; the paper treated only with a wet strength resin had a surface energy of 54 mJ/m² and a tensile loss of 0.80; and the paper treated with both a wet strength resin and a sizing agent had a surface energy of 34 mJ/m² and a tensile loss of 0.78. As shown in Table 2, raising the wet strength using wet strength resin can increase removal efficiencies. Moreover, as shown in Table 2, the best removal efficiencies are obtained when both the wet strength is raised and the surface energy of the paper substrate is lowered by means of a sizing agent.

TABLE 2

| Water-Based | Untreated | Wet-Strength | Sized Wet- |
|---|---|---|---|
| PSA | Paper | Paper | Strength Paper |
| 1 | 71.0 | 83.7 | 99.6 |
| 2 | 67.1 | 77.4 | 99.9 |
| 3 | 51.0 | 52.3 | 98.5 |
| 4 | 66.6 | 72.3 | 99.2 |
| 5 | 72.0 | 94.8 | 98.9 |
| 6 | 78.6 | 82.3 | 99.1 |
| 7 | 91.0 | 96.0 | 100 |
| 8 | 89.0 | 90.6 | 99.1 |

### Example 3

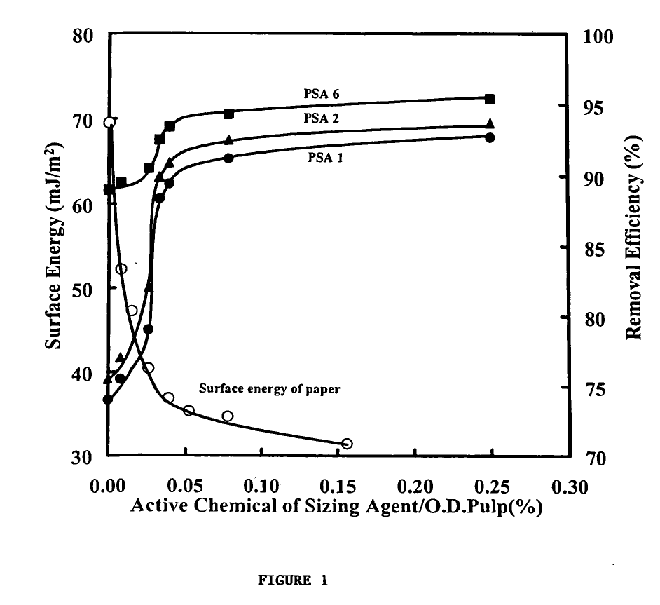

This example illustrates the influence on removal efficiency of lowering the surface energy of paper substrates provided with three different hot melt PSAs using a sizing agent. In each case, the paper was also treated with a wet strength resin. The surface energy of the paper substrate at various sizing levels is reported in Table 3 and FIG. 1. Superimposed on FIG. 1 are the removal efficiencies for the three hot melt PSAs.

TABLE 3

| Size Concentration (%) | Surface Energy (mJ/m²) |
|---|---|
| 0.000 | 69.51 |
| 0.008 | 52.21 |
| 0.015 | 47.23 |
| 0.026 | 40.39 |
| 0.040 | 36.83 |
| 0.052 | 35.35 |
| 0.078 | 34.69 |
| 0.156 | 31.43 |

A number of embodiments of the invention have been described. Nevertheless, it will be understood that various modifications may be made without departing from the spirit and scope of the invention. Accordingly, other embodiments are within the scope of the following claims.

1. An article comprising a paper substrate and an adhesive provided on said paper substrate,
said paper substrate having a surface energy no greater than about 55 mJ/m² and a wet strength that is maintained at a sufficiently high level when said article is subjected to repulping such that said substrate remains substantially intact at the conclusion of repulping.

2. An article according to claim 1 wherein said paper substrate has a surface energy of about 25-50 mJ/m².

3. An article according to claim 1 wherein said paper substrate has a surface energy of about 30-40 mJ/m².

4. An article according to claim 1 wherein said adhesive comprises a pressure sensitive adhesive.

5. An article according to claim 1 wherein said paper substrate is treated with a reagent selected from the group consisting of sizing agents, wet strength resins, and combination thereof.

6. An article according to claim 5 wherein said paper substrate is treated with a sizing agent.

7. An article according to claim 6 wherein said sizing agent selected from the group consisting of alkyl ketene dimers, alkenyl succinic anhydrides, rosin esters, and combinations thereof.

8. An article according to claim 5 wherein said paper substrate is treated with a wet strength resin.

9. An article according to claim 8 wherein said wet strength resin comprises a permanent wet strength resin.

10. An article according to claim 8 wherein said wet strength resin is selected from the group consisting of urea-formaldehyde resins, melamine formaldehyde resins, polyamide-epichlorohydrin resins, and combinations thereof.

11. An article according to claim 8 wherein said paper substrate is surface treated with said wet strength resin.

12. An article according to claim 1 wherein said article exhibits an adhesive removal efficiency of at least 85%.

13. An article according to claim 1 wherein said article exhibits an adhesive removal efficiency of at least 95%.

14. An article according to claim 1 wherein said article exhibits an adhesive removal efficiency of at least 99%.

15. An article comprising (a) a paper substrate treated with a sizing agent and a permanent wet strength resin and (b) an adhesive provided on said paper substrate,
said paper substrate having a surface energy of about 25-50 mJ/m² and a wet strength that is maintained at a sufficiently high level when said article is subjected to repulping such that said substrate remains substantially intact at the conclusion of repulping.
said article being screenable.

16. A recycling process comprising:
(a) providing a feedstock comprising an article comprising a paper substrate and an adhesive provided on said paper substrate, said paper substrate having a surface energy no greater than 55 mJ/m²; and
(b) repulping said feedstock, wherein said paper substrate remains substantially intact at the conclusion of repulping.
